(19) United States
(12) Patent Application Publication
(10) Pub. No.: US 2026/0304458 A1
(43) Pub. Date: Oct. 1, 2026

(54) ULTRA HIGH RELIABILITY ENHANCEMENTS TO NEIGHBOR REPORT AND BASIC SERVICE SET MEMBERSHIP SELECTOR

(71) Applicant: Cisco Technology, Inc., San Jose, CA (US)

(72) Inventors: Binita GUPTA, San Diego, CA (US); Brian D. HART, Sunnyvale, CA (US)

(21) Appl. No.: 19/633,464

(22) Filed: Mar. 30, 2026

Related U.S. Application Data
(60) Provisional application No. 63/781,153, filed on Mar. 31, 2025.

(51) Int. Cl. H04W 72/27; H04W 88/08; H04W 92/20

(52) U.S. Cl. CPC H04W 72/27; H04W 88/08; H04W 92/20

(57) ABSTRACT

Embodiments of the present disclosure provides techniques for signaling ultra high reliability (UHR) support in wireless networks, including determining, by an access point (AP), one or more Ultra High Reliability (UHR)-related parameters associated with a neighboring AP, and transmitting, by the AP, one or more management frames to a non-AP station (STA), the one or more management frames comprising UHR indication information, where the UHR indication information comprises at least one of a value indicating that the neighboring AP supports UHR operations, or one or more UHR-related subelements comprising the one or more UHR-related parameters.

### CROSS-REFERENCE TO RELATED APPLICATIONS

This application claims benefit of co-pending United States provisional patent application Serial No. 63/781,153 filed Mar. 31, 2025. The aforementioned related patent applications are herein incorporated by reference in their entirety.

### TECHNICAL FIELD

Embodiments presented in this disclosure generally relate to wireless communication. More specifically, embodiments disclosed herein relate to signaling ultra high reliability (UHR) capability from an access point (AP) to a non-AP station (STA) in wireless local area networks (WLANs).

### BACKGROUND

IEEE 802.11 defines a Neighbor Report (NR) element that allows an access point (AP) to provide a station (STA) with information about neighboring APs/basic service sets (BSSs) that may be suitable roaming or BSS transition candidates. Such neighbor information may be delivered, for example, in an 802.11k Neighbor Report Response frame, or may be conveyed in an 802.11v BSS Transition Management (BTM) Request frame or an access network query protocol (ANQP) response frame that includes a Neighbor Report ANQP-element, by including one or more Neighbor Report (NR) elements. As newer physical layer (PHY) features and operational modes are introduced, such as Ultra High Reliability (UHR) operation, STAs may benefit from being able to distinguish candidate APs/BSSs that support UHR from those that do not and to understand relevant UHR operating parameters.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless communication system, according to some embodiments of the present disclosure.

FIG. 2A depicts an example BSSID Information field of a Neighbor Report (NR) element, according to some embodiments of the present disclosure.

FIG. 2B depicts an example NR element, according to some embodiments of the present disclosure.

FIG. 3 depicts an example table of Optional Subelement Identifiers, according to some embodiments of the present disclosure.

FIG. 4 depicts an example (Extended) Supported Rates and BSS Membership Selectors element, according to some embodiments of the present disclosure.

FIG. 5 depicts an example table of BSS Membership Selector Value, according to some embodiments of the present disclosure.

FIG. 6 depicts an example method performed by a serving AP to provide neighbor information to a STA, according to some embodiments of the present disclosure.

FIG. 7 depicts an example method performed by a neighboring AP to provide UHR capability information to a STA, according to some embodiments of the present disclosure.

FIG. 8 is a block diagram depicting an example UHR reporting method performed by a serving AP, according to some embodiments of the present disclosure.

FIG. 9 is a block diagram depicting an example UHR reporting method performed by a neighboring AP, according to some embodiments of the present disclosure.

FIG. 10 depicts an example network device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including determining, by an access point (AP), one or more Ultra High Reliability (UHR)-related parameters associated with a neighboring AP, and transmitting, by the AP, one or more management frames to a non-AP station (STA), the one or more management frames comprising UHR indication information, where the UHR indication information comprises at least one of a value indicating that the neighboring AP supports UHR operations, or one or more UHR-related subelements comprising the one or more UHR-related parameters.

One embodiment presented in this disclosure provides a method, including determining, by an access point (AP), that support for an Ultra High Reliability (UHR) physical layer (PHY) is required for a non-AP station (STA) to join a Basic Service Set (BSS) associated with the AP, and transmitting, by the AP, one or more management frames to a non-AP STA, the one or more management frames comprising UHR indication information, where the UHR indication information comprises a Basic Service Set (BSS) membership selector value indicating a requirement for support of the UHR PHY.

Other embodiments in this disclosure provide a computer program product comprising one or more computer-readable storage media collectively containing computer-readable program code that, when executed by operation of one or more computer processors, performs operations in accordance with one or more of the above methods, and a system of a network device comprising one or more computer processors, and one or more memories collectively containing one or more programs, which, when executed by the one or more computer processors, perform operations in accordance with one or more of the above methods

### Example Embodiments

A Neighbor Report (NR) element is defined to allow a reporting access point (AP) to provide a non-AP station (STA) with information associated with neighboring APs/Basic Service Sets (BSSs) that may serve as roaming candidates. Such neighbor information may be delivered in a variety of manners, including in an 802.11k Neighbor Report Response frame, or in an 802.11v BSS Transition Management (BTM) Request frame by including one or more NR elements in a BSS Transition Candidate List. As newer operational modes and reliability-focused features are introduced, such as Ultra High Reliability (UHR) operation, a STA may benefit from receiving explicit signaling that distinguishes UHR-supported candidate APs/BSSs from non-UHR candidates, and/or from obtaining sufficient UHR-related parameters to support candidate ranking, transition decisions, and association behavior. Without a reporting mechanism that explicitly indicates UHR capability and related operating parameters in the management frames used for discovery and steering, a STA may select a candidate AP that cannot provide the intended UHR service, may expend additional airtime probing to infer UHR capability, and/or may experience failed or inefficient association attempts when UHR support is required but not clearly advertised.

Embodiments of the present disclosure present methods, systems, and apparatuses for signaling UHR capability from an AP to a non-AP STA using information elements that participate in neighbor reporting and BSS admission signaling. More specifically, in one embodiment, a reporting AP includes UHR indication information in an NR element (transmitted to a STA) for a reported (or candidate) neighboring AP. A reserved bit (or other value) in a BSSID Information field may be set to indicate that the reported AP is UHR-capable, and UHR-related information may be included in an Optional Subelements field, such as a UHR Capabilities subelement and/or a UHR Operation subelement. Through this approach, the NR entry corresponding to a given candidate AP can directly convey that candidate’s UHR support and associated parameters within the same neighbor-reporting structure that is carried in an 802.11k Neighbor Report Response frame or an 802.11v BTM Request frame.

In another embodiment, an AP advertises UHR PHY support and/or a requirement for UHR PHY support to join a BSS by including a newly defined BSS membership selector value in an (Extended) Supported Rates and BSS Membership Selectors element transmitted in one or more management frames, such as a Beacon frame, a Probe Response frame, or a (Re)association Response frame.

The disclosed reporting mechanisms enable the STA to make more accurate candidate selection and transition steering toward UHR-supported APs/BSSs. The mechanisms also reduce probing overhead and decrease the likelihood of failed roaming or association attempts caused by undisclosed UHR requirements. Further, by permitting UHR-related operational details to be conveyed through optional subelements, the disclosed techniques support scalable signaling and maintain compatibility with existing neighbor reporting and BSS membership selector frameworks.

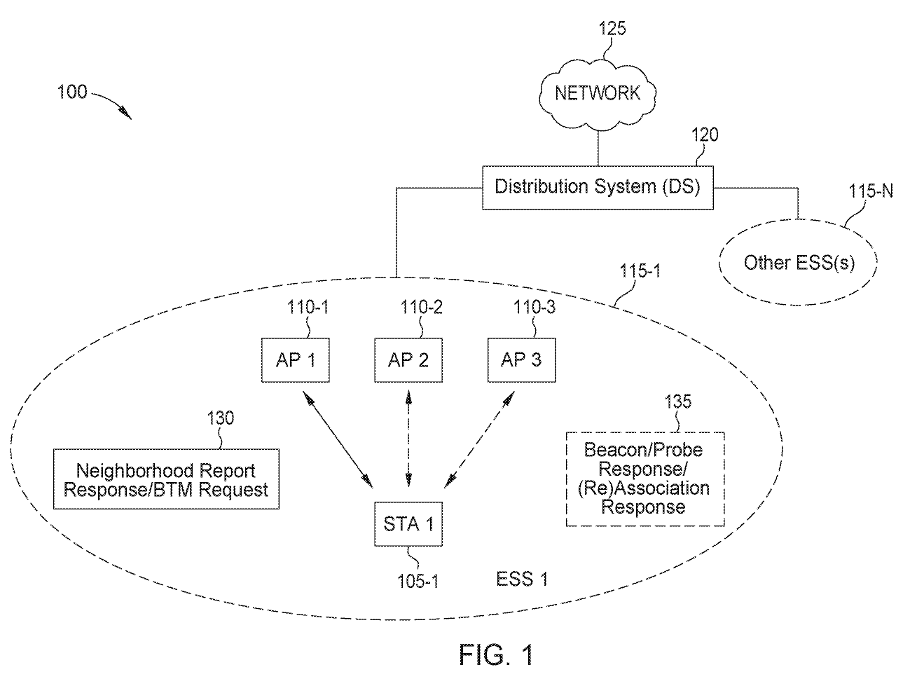

FIG. 1 depicts an example wireless communication system 100. As depicted, the example system 100 includes a distribution system (DS) 120 coupled to a network 125, a first extended service set (ESS) 115-1, and one or more additional ESSs 115-N. In some embodiments, ESS 1 (115-1) and the one or more additional ESSs 115-N are connected via the DS 120.

As shown, ESS 1 (115-1) includes AP 1 (110-1), AP 2 (110-2), and AP 3 (110-3), where AP 1 (110-1) is associated with STA 1 (105-1). The one or more additional ESSs 115-N may include one or more additional APs (not shown). STA 1 (105-1) may roam to a neighboring AP within the ESS, such as AP 2 or AP 3 within ESS 1 (115-1), and/or to an AP in one of the additional ESSs 115-N (or BSSs in embodiments when a BSS includes multiple APs). APs 110 in different ESSs may communicate with each other and/or access the network 125 through DS 120. The network 125 may include, but is not limited to, the Internet, an intranet, a local area network (LAN), a wide area network (WAN), a cellular core network, or a cloud network.

During operation, management frames 130 may be exchanged between AP 1 (110-1) and STA 1 (105-1) to support neighbor discovery and transition operations. For example, AP 1 (110-1) may transmit a Neighbor Report Response to STA 1 (105-1) in response to a Neighbor Report Request, or AP 1 (110-1) may transmit a BTM Request to STA 1 (105-1) to facilitate roaming across BSSs in the ESS. In some embodiments, the BTM Request may include a BSS Transition Candidate List including one or more Neighbor Report (NR) elements associated with candidate APs, such as AP 2 (110-2) and AP 3 (110-3). Accordingly, AP 1 (110-1) may provide STA 1 (105-1) with information regarding neighboring candidate APs through management frames 130 such that STA 1 can evaluate whether roaming to one of the candidate APs is desirable.

STAs may also directly communicate with one or more neighboring APs, such as AP 2 (110-2) and AP 3 (110-3), through management frames 135. For example, management frames 135 may include Beacon frames, Probe Response frames, and/or (Re)Association Response frames associated with AP 2 (110-2) and AP 3 (110-3). Through such communications, STA 1 may obtain additional information regarding a neighboring BSS before or during a roaming or associated procedure.

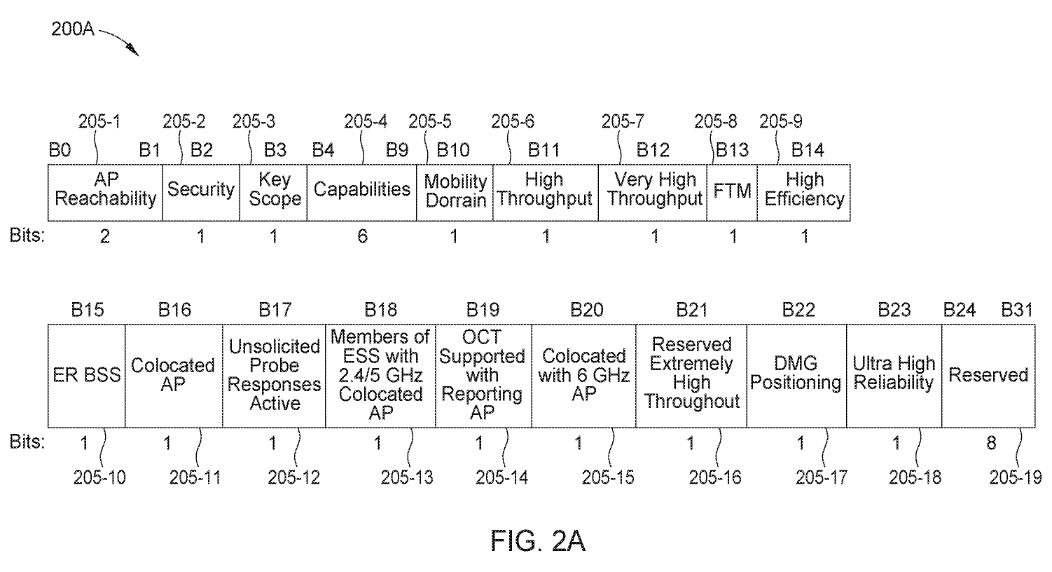

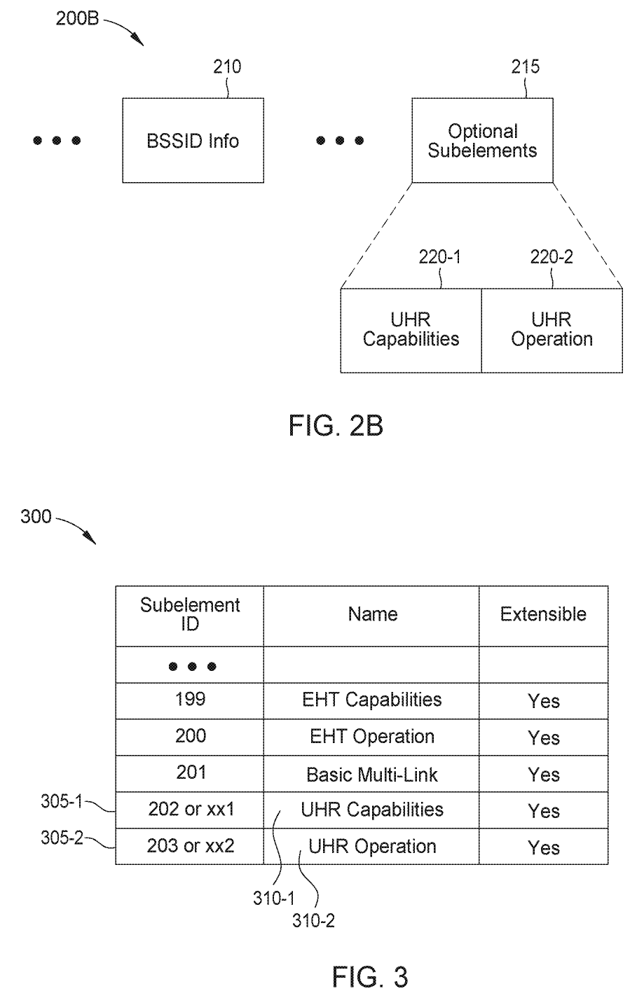

As discussed above, NR information may be conveyed to STA 1 (105-1) through management frames 130 or 135 to indicate characteristics of candidate APs. As Ultra High Reliability (UHR) operation is developed and supported in wireless local area networks (WLANs), STA 1 may benefit from knowing whether a candidate AP, such as AP 2 (110-2) or AP 3 (110-3), supports UHR operations, and/or whether support for a UHR physical layer (PHY) is required to join a corresponding BSS. Providing such information can improve candidate evaluation, reduce unnecessary probing and failed transition attempts, and support more efficient roaming decisions. In some embodiments, UHR-related information may be included in an NR element transmitted from AP 1 (110-1) to STA 1 (105-1), such as in management frames 130 including a Neighbor Report Response frame or a BTM Request frame, to indicate that a reported candidate AP supports UHR operation. For example, a reserved bit in a BSSID Information field of the NR element may be used to indicate that the reported AP supports UHR operation. To convey additional UHR-related parameters, new optional subelement values may be defined such that one or more additional subelements, such as a UHR Capabilities subelement and/or a UHR Operation subelement, may be included. In some embodiments, UHR-related information may be conveyed in management frames 135 transmitted by AP 2 (110-2) and/or AP 3 (110-3) to STA 1 (105-1), such as through signaling that indicates support for a UHR PHY or that such support is required for association with a corresponding BSS. Additional details regarding email techniques for including such UHR information are discussed below with reference to FIGS. 2 and 3.

FIG. 2A depicts an example BSSID Information field 200A of a Neighbor Report (NR) element, according to some embodiments of the present disclosure.

As shown, the BSSID Information field 200A includes a plurality of bit positions associated with respective parameters or capability indicators for a reported (or neighboring) AP (e.g., AP 2 (110-2) or AP 3 (110-3) in FIG. 1), such as AP reachability, security, key scope, capabilities, mobility domain, high throughput (HT), very high throughput (VHT), fine timing measurement (FTM), high efficiency (HE), emergency response (ER) BSS, collocated AP indication, unsolicited probe response capability, collocated 2.4/5 GHz AP membership, collocated 6 GHz AP indication, extremely high throughput (EHT), directional multi-gigabit (DMG) positioning, and one or more reserved bit positions. As used herein, the AP Reachability field 205-1 includes information indicating reachability characteristics of the reported neighboring AP. The Security field 205-2 indicates whether the reported neighboring AP requires security for association. The Key Scope field 205-3 indicates whether the encryption keys are scoped to a mobility domain. The Capabilities field 205-4 indicates capability characteristics of the reported AP. The Mobility Domain field 205-5 indicates whether the reported AP belongs to a mobility domain that supports seamless roaming procedures. The HT field 205-6 indicates whether the reported neighboring AP supports HT operation. The VHT field 205-7 indicates whether the reported AP supports VHT operation. The FTM field 205-8 indicates whether the reported AP supports FTM functionality. The High Efficiency (HE) field 205-9 indicates whether the reported AP supports HE operation. The ER BSS field 205-10 indicates whether the reported AP belongs to an emergency response BSS. The Co-located AP Indication field 205-11 indicates whether the reported AP is co-located with another AP. The Unsolicited Probe Response Capability field 205-12 indicates whether the reported neighboring AP supports unsolicited probe response transmissions. The Members of ESS with 2.4/5 GHz Co-located AP field 205-13 indicates whether the reported AP is part of a group of co-located APs operating in the 2.4 GHz or 5 GHz bands. The OCT Supported with Reporting AP field 205-14 indicates whether over-the-air coexistence or coordinated operations are supported between the reported AP and the serving AP. The Co-located 6 GHz AP field 205-15 indicates whether the AP is associated with a co-located AP operating in the 6 GHz band. The EHT field 205-16 indicates whether the reported AP supports EHT operation. The DMG Positioning field 205-17 indicates whether the reported AP supports DMG positioning capabilities. Though the illustrated example includes a variety of parameters and indicators at corresponding bit positions, the particular parameters and positions (as well as bit widths used to encode each) may vary depending on the particular implementation, and may include more (or fewer) parameters and indicators.

In some embodiments of the present disclosure, one or more of the reserved bit positions, shown as field 205-18, is used to indicate whether a reported (or neighboring) AP identified by the NR element supports UHR operation. For example, field 205-18 may correspond to bit position B23, although other reserved or available bit positions (e.g., within the Reserved field 205-19) may be used. The field 205-18 may be set to a first value (e.g., “1”) to indicate that the reported AP (e.g., AP 2 (110-2) or AP 3 (110-3) in FIG. 1) supports UHR operations, and may be set to a second value (e.g., “0”) to indicate that the reported AP does not support UHR operation (or that UHR support is not indicated, in some aspects). When a reporting AP (e.g., AP 1 (110-1) in FIG. 1) transmits the NR element to a non-AP STA (e.g., STA 1 (105-1) in FIG. 1), such as in a Neighbor Report Response frame or a BTM Request frame including a BSS Transition Candidate List (e.g., 130 in FIG. 1), the UHR indication carried by field 205-18 may be used together with one or more optional subelements of the NR element to convey additional UHR-related information for the reported (or neighboring) AP, as discussed in more detail below with reference to FIG. 2B.

FIG. 2B depicts an example NR element 200B. As shown, the NR element 200B includes a BSSID Information field 210 and an Optional Subelements field 215. The BSSID Information field 210 may correspond to the BSSID Information field 200A described with reference to FIG. 2A and may include UHR capability indicators (e.g., within the field 205-18 in FIG. 2A) associated with a reported neighboring AP. In some embodiments, each NR element corresponds to one reported neighboring AP. When information for multiple reported APs is provided, multiple NR elements may be included in a Neighbor Report Response frame or a BTM Request frame (e.g., 130 in FIG. 1), where each NR element corresponds to a different reported AP.

As depicted, when BSSID Information field 210 includes a UHR capability indicator (e.g., within the field 205-18 in FIG. 2A), the Optional Subelements field 215 may include one or more subelements configured to convey UHR-related information, such as a UHR Capabilities subelement 220-1 and/or a UHR Operation subelement 220-2. Each subelement may include an Element ID field configured to indicate a type of the subelement, a Length field configured to indicate a size of the subelement, and one or more additional fields configured to carry data associated with the corresponding UHR-related parameters.

FIG. 3 depicts an example table 300 of Optional Subelement Identifiers (ID). The Subelement ID may be included in the Element ID field of each subelement, such as the UHR Capabilities subelement 220-1 and/or the UHR Operation subelement 220-2 as depicted in FIG. 2B. The corresponding subelement may be included within the Optional Subelements field of an NR element carried in a Neighbor Report Response frame or in a BTM Request frame (e.g., 130 in FIG. 1). In the illustrated example, ID 202 (305-1) is associated with a UHR Capabilities subelement 310-1 (which corresponds to the UHR Capabilities subelement 220-1 as depicted in FIG. 2B), and ID 203 (305-2) is associated with a UHR Operation subelement 310-2 (which corresponds to the UHR Operation subelement 220-2 as depicted in FIG. 2B). The example ID values 202-203 are provided for conceptual clarity, and in other embodiments, different ID values may be defined and used.

In the example table 300, example ID values 199-201 correspond to existing subelements defined in IEEE 802.11 specifications. For example, the subelement ID 199 is used to indicate an EHT Capabilities subelement, the subelement ID 200 is used to indicate an EHT Operation subelement, and the subelement ID 201 is used to indicate a Basic Multi-Link subelement.

In some embodiments, the UHR Capabilities subelement 310-1 may include parameters associated with capability features supported by the reported AP for UHR operation, such as supported UHR modes, supported channel bandwidths, modulation and coding support, multi-link support, reliability-related features, or other UHR capability information.

In some embodiments, the UHR Operation subelement 310-2 may include operational parameters associated with UHR operation of the reported AP, such as operating class information, link configuration, channel information, or timing-related parameters.

In some embodiments, a UHR Operation element 310-2 included in another management frame, such as a Beacon frame, omits one or more UHR-related parameters to limit signaling overhead and/or limit beacon bloating. Accordingly, one or more optional subelements of the NR element may be included to provide additional UHR-related information associated with a reported (or neighboring) AP. In this manner, a relatively compact indication of UHR support may be provided in a Beacon frame, and further UHR details may be transmitted through optional subelements when additional information is useful for roaming decisions.

The optional subelements 310-1 to 310-3 shown in FIG. 3 are provided for conceptual clarity. In some embodiments, other UHR-related optional subelements may be defined, and corresponding subelement ID values may be defined in table 300 for such additional optional subelements.

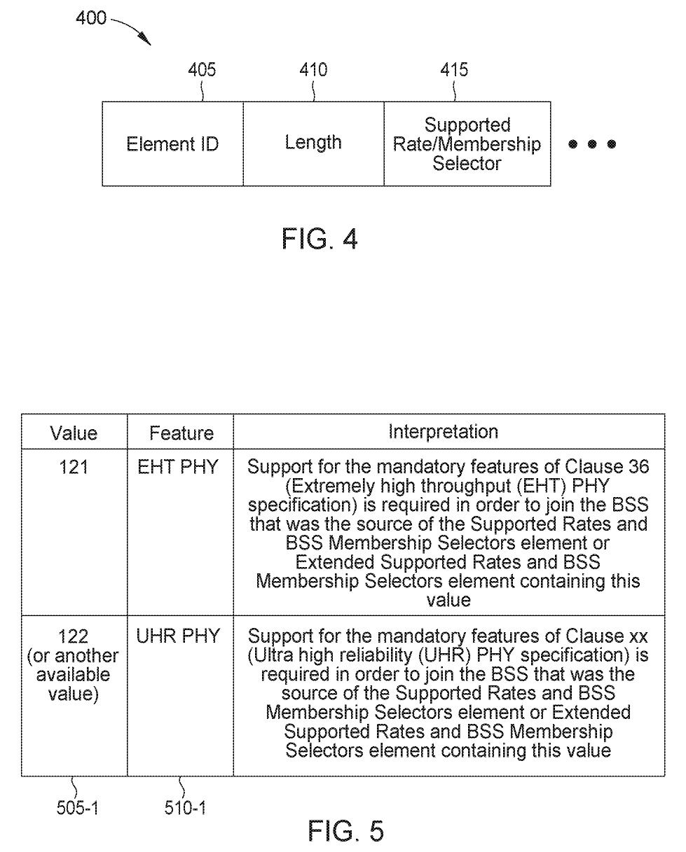

FIG. 4 depicts an example (Extended) Supported Rates and BSS Membership Selectors element 400 that may be used to convey UHR PHY capability information. The (Extended) Supported Rates and BSS Membership Selectors element 400 may be included in one or more management frames transmitted by an AP, such as a Beacon frame, a Probe Response frame, or a (Re)Association Response frame.

As depicted, the element 400 includes an Element ID field 405, a Length field 410, and a Supported Rate/Membership Selector field 415. The Element ID field 405 may indicate that the element corresponds to a Supported Rates and BSS Membership Selectors element (or an Extended Supported Rates and BSS Membership Selectors element). The Length field 410 may indicate the length of the element body, such as the number of octets included in the Supported Rate/Membership Selector field 415. The Supported Rate/Membership Selector field 415 may include one or more octets, where each octet may correspond to either a supported data rate or a BSS membership selector value associated with the BSS. As used herein, a BSS membership selector value indicates whether support for mandatory requirements for a specific physical layer (PHY) capability or features is required for a STA to join a BSS associated with an AP.

In the illustrated example, one of the values included in the Supported Rate/Membership Selector field 415 corresponds to (e.g., is used as) a UHR PHY membership selector. The UHR PHY membership selector may be a specific value indicating support for an ultra high reliability (UHR) physical layer (PHY) is required to join the BSS. For example, a new BSS membership selector value may be defined for the UHR PHY membership selector field, as more detail is depicted in FIG. 5.

As discussed, the (Extended) Supported Rates and BSS Membership Selectors element 400 may be included in one or more management frames transmitted by an AP, such as a Beacon frame, a Probe Response frame, a (Re)Association Response frame, a Link Reconfiguration Response frame, or a Link Reconfiguration Notify frame. Accordingly, a STA may determine, based on the presence of the UHR PHY Membership Selector field, whether a corresponding BSS supports UHR operation and/or whether support for the UHR PHY is required to join the BSS. With the signaled information, the STA may evaluate candidate BSSs (e.g., 115-N in FIG. 1) and make association or roaming decisions based on the UHR capability.

The example fields illustrated in FIG. 4 are provided for conceptual clarity. In some embodiments, the element 400 may include additional fields, a subset of the illustrated fields, or fields arranged in a different order.

FIG. 5 depicts an example table 500 of BSS Membership Selector Value that may be used to indicate support for a UHR PHY. The table 500 may correspond to an example mapping between BSS membership selector values and corresponding PHY features for use in an (Extended) Supported Rates and BSS Membership Selectors element 400 as depicted in FIG. 4.

As shown, the table 500 includes a new value, 122 (505-1), that is associated with a UHR PHY 510-1. The value 122 may be included within a Supported Rate/Membership Selector field (e.g., 415 in FIG. 4) within the Supported Rates and BSS Membership Selectors element (or Extended Supported Rates and BSS Membership Selectors element) (e.g., 400 in FIG. 4) to indicate that support for the mandatory features of UHR PHY is required for a STA to join the BSS associated with the transmitting AP. Accordingly, when an AP (e.g., an AP in one of the neighboring BSSs 115-N in FIG. 1) includes the UHR PHY membership selector value in the (Extended) Supported Rates and BSS Membership Selectors element, a STA receiving the corresponding management frame may determine that support for the UHR PHY is required to associate with the BSS associated with the AP. Following that, the AP may determine whether it satisfies the PHY capability requirements of the BSS prior to association or reassociation.

In some embodiments, the UHR PHY membership selector value is included only when support for the UHR PHY is required to join the BSS. In cases where the BSS supports UHR operation but does not require that joining STAs support the UHR PHY, the UHR PHY membership selector value may be omitted, allowing legacy STAs to associate with the BSS.

In the example table 500, the value 121 corresponds to an existing predefined membership selector value indicating support for an Extremely High Throughput (EHT) PHY feature, where the presence of the value 121 indicates that support for the mandatory features of the EHT PHY specification is required for a STA to join the BSS associated with the transmitting AP.

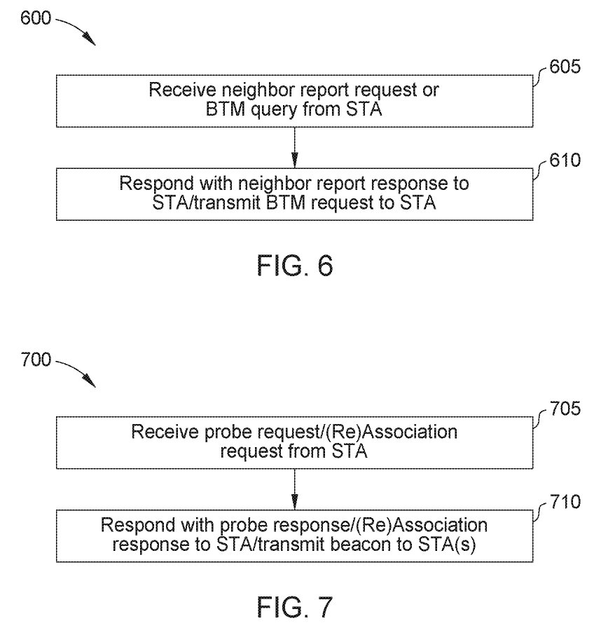

FIG. 6 depicts an example method 600 performed by a serving AP to provide neighbor information to a STA. The serving AP may correspond to the AP 1 (110-1) in FIG. 1, and the STA may correspond to the STA 1 (105-1) in FIG. 1.

At block 605, the serving AP (e.g., AP 1 (110-1) in FIG. 1) receives a Neighbor Report Request frame from an associated STA (e.g., STA 1 (105-1) in FIG. 1). The Neighbor Report Request frame is sent by the STA to request information about neighboring APs (e.g., AP 2 (110-2), AP 3 (110-3), or APs in other BSSs (115-N) in FIG. 1).

In some embodiments, the serving AP (e.g., AP 1 (110-1) in FIG. 1) receives a BTM Query frame from an associated STA (e.g., STA 1 (105-1) in FIG. 1). The BTM Query frame is sent by the STA to query information about neighboring APs (e.g., AP 2 (110-2), AP 3 (110-3), or APs in other ESSs (115-N) (or BSSs) in FIG. 1).

At block 610, the serving AP transmits a Neighbor Report Response frame (e.g., 130 in FIG. 1) to the STA. In some embodiments, the Neighbor Report Response frame includes one or more NR elements (e.g., 200B in FIG. 2B) associated with candidate APs. The NR elements may identify one or more neighboring APs and may include information associated with those APs that may be used by the AP when evaluating roaming or transition candidates. For example, the NR elements may include information indicating whether a reported AP supports UHR operation (e.g., through the Ultra High Reliability field 205-18) and/or may include one or more optional subelements (e.g., the UHR Capabilities subelement 220-1 or UHR Operation subelement 220-2 in FIG. 2B) conveying additional UHR-related parameters associated with the reported AP.

In some embodiments, the serving AP provides neighbor information through a BTM Request frame (e.g., 130 in FIG. 1) instead of (or in addition to) a Neighbor Report Response frame. In such cases, at block 605, as discussed above, a BTM Query frame is received, or block 605 is omitted. In the first case, the serving AP transmits a BTM Request in response to a BTM Query. In the second case, the serving AP may autonomously transmit the BTM Request to the STA as an unsolicited frame. The BTM request may include a BSS Transition Candidate List that includes one or more NR elements (e.g., 200B in FIG. 2B) associated with candidate APs. Each NR element may indicate whether a reported AP supports UHR operation and/or include one or more optional subelements (e.g., the UHR Capabilities subelement 220-1 or UHR Operation subelement 220-2 in FIG. 2B) for transmitting additional UHR-related parameters.

FIG. 7 depicts an example method 700 performed by a neighboring AP to provide UHR capability information to a STA. The STA may correspond to the STA 1 (105-1) in FIG. 1. The neighboring AP may correspond to an AP located within the same ESS (e.g., ESS 1 (115-1) in FIG. 1) as the STA or to an AP within a neighboring ESS (e.g., other ESS(s) (115-N) in FIG. 1). The neighboring AP may serve as a candidate AP to which the STA may roam during roaming procedures.

At block 705, the neighboring AP receives a Probe Request frame or a (Re)Association Request frame transmitted by the STA. For example, the STA may transmit a Probe Request to discover available APs in the surrounding wireless environment, or may transmit a (Re)Association Request when attempting to associate or reassociate with the neighboring AP.

At block 710, the neighboring AP transmits a Probe Response frame or a (Re)Association Response frame (e.g., 135 in FIG. 1) to the STA. In some embodiments, the transmitted management frame may include capability information associated with the BSS to which the neighboring AP belongs. For example, the management frame may include an (Extended) Supported Rates and BSS Membership Selectors element (e.g., 400 in FIG. 4). The element may include a BSS membership selector value (e.g., value 122 in FIG. 5) indicating whether support for an UHR PHY is required for a STA to join the BSS associated with the neighboring AP.

In some embodiments, the neighboring AP transmits Beacon frames (e.g., 135 in FIG. 1) that are broadcast to STAs within communication range of the AP. The Beacon frames may also include the (Extended) Supported Rates and BSS Membership Selectors element (e.g., 400 in FIG. 4) described herein. In such cases, block 705 is omitted, and the neighboring AP transmits the Beacon frame to its surrounding STAs prior to association.

The example management frames described herein, such as a Neighbor Report Response frame, a BTM Request frame, a Beacon frame, a Probe Response frame, and/or a (Re)Association Response frame, are provided for conceptual clarity. In some embodiments, other types of frames that include an NR element or an (Extended) Supported Rates and BSS Membership Selectors element may be used to convey the UHR-related information.

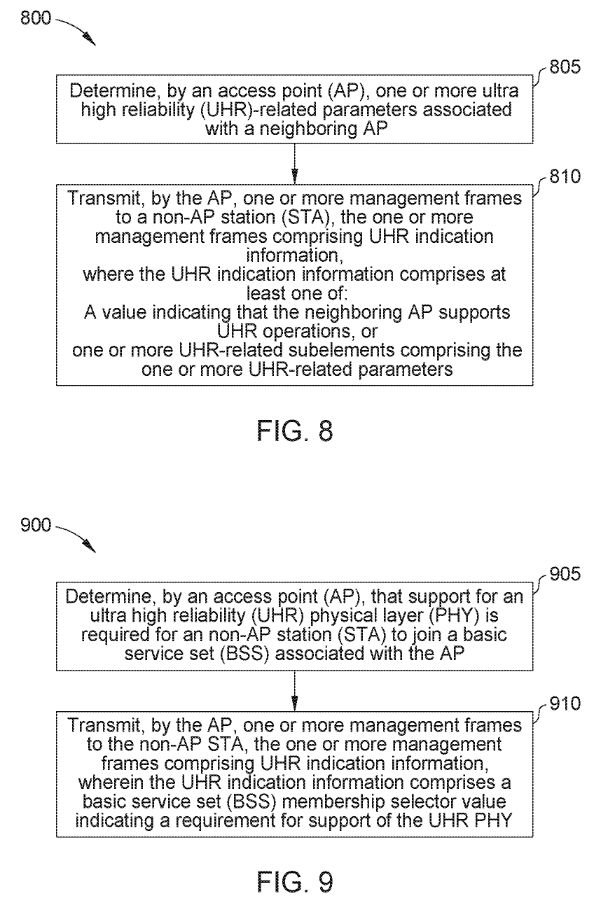

FIG. 8 is a block diagram depicting an example UHR reporting method 800 performed by a serving AP, according to some embodiments of the present disclosure.

At block 805, a serving AP (e.g., AP 1 (110-1) in FIG. 1) determines one or more Ultra High Reliability (UHR)-related parameters associated with a neighboring AP (e.g., AP 2 (110-2) or AP 3 (110-3) in FIG. 1).

At block 810, the serving AP transmits one or more management frames to a non-AP STA (e.g., STA 1 (105-1) in FIG. 1), the one or more management frames (e.g., 130 in FIG. 1) comprising UHR indication information, where the UHR indication information comprises at least one of: a value indicating that the neighboring AP supports UHR operations, or one or more UHR-related subelements comprising the one or more UHR-related parameters.

In some embodiments, the UHR indication information is carried in a Neighbor Report (NR) element (e.g., 200B in FIG. 2B).

In some embodiments, the NR element identifies the neighboring AP using a Basic Service Set Identifier (BSSID) corresponding to the neighboring AP.

In some embodiments, the value indicating that the neighboring AP supports UHR operations is carried in a Basic Service Set Identifier (BSSID) Information field (e.g., 200A in FIG. 2A) of the NR element.

In some embodiments, the one or more UHR-related subelements (e.g., the UHR Capabilities subelement 220-1 or UHR Operation subelement 220-2, in FIG. 2B) are carried in an Optional Subelements field (e.g., 215 in FIG. 2B) of the NR element (e.g., 200B in FIG. 2B).

In some embodiments, the one or more management frames comprise at least one of: a Neighbor Report Response frame, a Basic Service Set (BSS) Transition Management (BTM) Request frame, an Access Network Query Protocol (ANQP) Response frame that comprises a Neighbor Report ANQP-element, a Probe Response frame, an Association Response frame, a Reassociation Response frame, a Link Reconfiguration Response frame, or a Link Reconfiguration Notify frame.

In some embodiments, one or more subelement values are defined for the one or more UHR-related subelements, comprising at least one of: a first subelement value identifying a UHR Capabilities subelement (e.g., 220-1 in FIG. 2B), or a second subelement value identifying a UHR Operation subelement (e.g., 220-2 in FIG. 2B).

FIG. 9 is a block diagram depicting an example UHR reporting method 900 performed by a neighboring AP, according to some embodiments of the present disclosure.

At block 905, a neighboring AP (e.g., AP 2 (110-2) or AP 3 (110-3) in FIG. 1) determines that support for an Ultra High Reliability (UHR) physical layer (PHY) is required for a non-AP station (STA) to join a Basic Service Set (BSS) associated with the AP.

At block 910, the neighboring AP transmits one or more management frames (e.g., 135 in FIG. 1) to the non-AP STA (e.g., STA 1 (105-1) in FIG. 1), the one or more management frames comprising UHR indication information, where the UHR indication information comprises a Basic Service Set (BSS) membership selector value (e.g., value 122 in FIG. 5) indicating a requirement for support of the UHR PHY.

In some embodiments, the BSS membership selector value (e.g., value 122 in FIG. 5) is carried in at least one of a Supported Rates and BSS Membership Selectors element or an Extended Supported Rates and BSS Membership Selectors element (e.g., 400 in FIG. 4).

In some embodiments, a presence of the BSS membership selector value indicates that the BSS associated with the AP is a UHR BSS.

In some embodiments, the AP rejects an association request from the non-AP STA in response to determining that the non-AP STA does not support the UHR PHY.

In some embodiments, the AP accepts an association request from the non-AP STA in response to receiving an indication that the non-AP STA supports the UHR PHY, and the AP transmits an association response indicating successful association.

In some embodiments, the one or more management frames comprise at least one of: a Beacon frame, a Probe Response frame, an Association Response frame, a Reassociation Response frame, a Link Reconfiguration Response frame, or a Link Reconfiguration Notify frame.

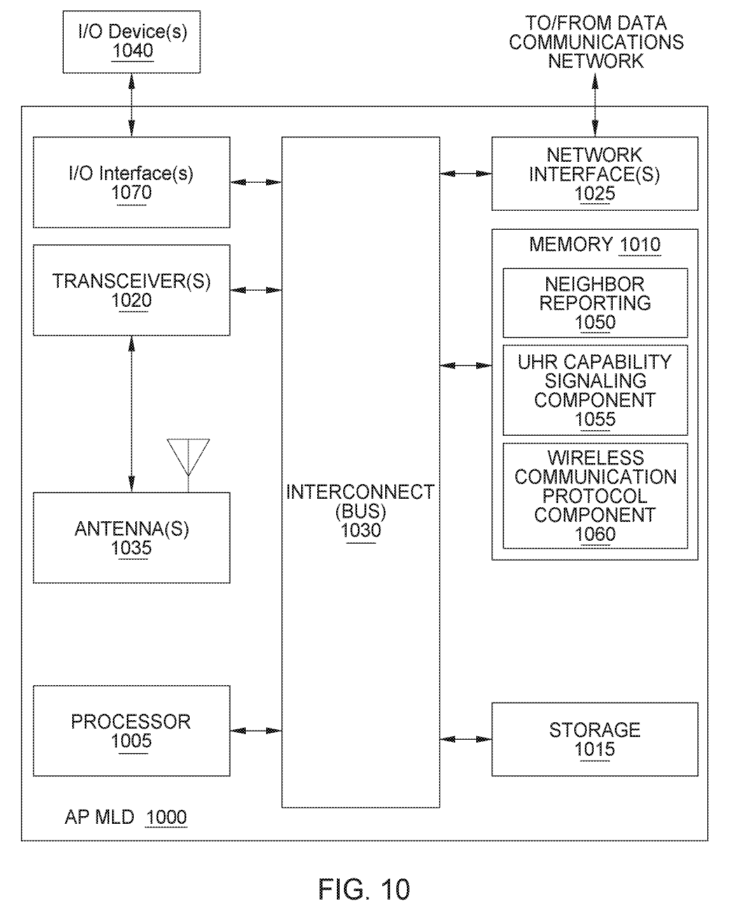

FIG. 10 depicts an example network device 1000 configured to perform various aspects of the present disclosure, according to some embodiments of the present disclosure. The example network device 1000 may correspond to a serving AP, such as the AP 1 (110-1) as depicted in FIG. 1, or a target AP, such as the AP 2 (110-2) or AP 3 (110-3) in FIG. 1.

As illustrated, the AP MLD 1000 includes a processor 1005, memory 1010, storage 1015, one or more transceivers 1020, one or more I/O interfaces 1090, and one or more network interfaces 1025. In some embodiments, I/O devices 1040 are connected via the I/O interface(s) 1080. Further, via the network interface 1025, the AP MLD 1000 can be communicatively coupled with one or more other devices and components (e.g., via a network, which may include the Internet, local network(s), and the like). Each of the components is communicatively coupled by one or more buses 1030. In some embodiments, one or more antennas 1035 may be coupled to the transceivers 1020 for transmitting and receiving wireless signals.

The processor 1005 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1005 processes information received through the transceivers 1020, I/O interfaces 1090, and the network interfaces 1025. The processor 1005 retrieves and executes programming instructions stored in memory 1010, as well as stores and retrieves application data residing in storage 1015.

The storage 1015 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1015 may store a variety of data for the efficient functioning of the system.

The memory 1010 may include random access memory (RAM) and read-only memory (ROM). The memory 1010 may store processor-executable software code containing instructions that, when executed by the processor 1005, enable the AP MLD 1000 to perform various functions described herein for wireless communication.

As depicted, the memory 1010 includes a neighbor reporting component 1050, a UHR capability signaling component 1055, and a wireless communication protocol component 1060.

In one embodiment, the neighbor reporting component 1050 is configured to generate and transmit neighbor reporting information when the network device 1000 operates as a serving AP (e.g., the AP 1 (110-1) of FIG. 1). For example, the neighbor reporting component 1050 may receive a Neighbor Report Request from an associated STA and generate a Neighbor Report Response (e.g., 130 in FIG. 1) including one or more Neighbor Report (NR) elements (e.g., 200B in FIG. 2B) identifying candidate APs (e.g., the AP 2 (110-2) or AP 3 (110-3) in FIG. 1), and/or may generate a BTM Request (e.g., 130 in FIG. 1) including a BSS Transition Candidate List that comprises NR elements (e.g., 200B in FIG. 2B) associated with candidate APs.

In one embodiment, the UHR capability signaling component 1055 is configured to communicate UHR capability information when the network device 1000 operates as a neighboring or candidate AP (e.g., the AP 2 (110-2) or AP 3 (110-3) in FIG. 1). For example, the UHR capability signaling component 1055 may generate management frames, such as Beacon frames, Probe Response frames or (Re)Association Response frames (e.g., 135 in FIG. 1), which include an (Extended) Supported Rates and BSS Membership Selectors element (e.g., 400 in FIG. 4) indicating whether the BSS associated with the AP supports or requires a UHR PHY.

In one embodiment, the wireless communication protocol component 1060 is configured to implement relevant wireless communication procedures and manage wireless communication through the transceiver 1020 and antenna 1035, including transmission and reception of management frames and other wireless signaling associated with the techniques described herein.

Although depicted as a discrete component for conceptual clarity, in some embodiments, the operations of the depicted components (and others not illustrated) may be combined or distributed across any number of components. Further, although depicted as software residing in memory 1010, in some embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
determining, by an access point (AP), one or more Ultra High Reliability (UHR)-related parameters associated with a neighboring AP; and
transmitting, by the AP, one or more management frames to a non-AP station (STA), the one or more management frames comprising UHR indication information,
wherein the UHR indication information comprises at least one of:
a value indicating that the neighboring AP supports UHR operations, or
one or more UHR-related subelements comprising the one or more UHR-related parameters.

2. The method of claim 1, wherein the UHR indication information is carried in a Neighbor Report (NR) element.

3. The method of claim 2, wherein the NR element identifies the neighboring AP using a Basic Service Set Identifier (BSSID) corresponding to the neighboring AP.

4. The method of claim 2, wherein the value indicating that the neighboring AP supports UHR operations is carried in a Basic Service Set Identifier (BSSID) Information field of the NR element.

5. The method of claim 2, wherein the one or more UHR-related subelements are carried in an Optional Subelements field of the NR element.

6. The method of claim 1, wherein the one or more management frames comprise at least one of:
a Neighbor Report Response frame,
a Basic Service Set (BSS) Transition Management (BTM) Request frame,
an Access Network Query Protocol (ANQP) Response frame that comprises a Neighbor Report ANQP-element,
a Probe Response frame,
an Association Response frame,
a Reassociation Response frame,
a Link Reconfiguration Response frame, or
a Link Reconfiguration Notify frame.

7. The method of claim 1, wherein one or more subelement values are defined for the one or more UHR-related subelements, comprising at least one of:
a first subelement value identifying a UHR Capabilities subelement, or
a second subelement value identifying a UHR Operation subelement.

8. A method, comprising:
determining, by an access point (AP), that support for an Ultra High Reliability (UHR) physical layer (PHY) is required for a non-AP station (STA) to join a Basic Service Set (BSS) associated with the AP; and
transmitting, by the AP, one or more management frames to the non-AP STA, the one or more management frames comprising UHR indication information,
wherein the UHR indication information comprises a Basic Service Set (BSS) membership selector value indicating a requirement for support of the UHR PHY.

9. The method of claim 8, wherein the BSS membership selector value is carried in at least one of a Supported Rates and BSS Membership Selectors element or an Extended Supported Rates and BSS Membership Selectors element.

10. The method of claim 8, wherein a presence of the BSS membership selector value indicates that the BSS associated with the AP is a UHR BSS.

11. The method of claim 10, wherein the AP rejects an association request from the non-AP STA in response to determining that the non-AP STA does not support the UHR PHY.

12. The method of claim 10, wherein the AP accepts an association request from the non-AP STA in response to receiving an indication that the non-AP STA supports the UHR PHY, and the AP transmits an association response indicating successful association.

13. The method of claim 8, wherein the one or more management frames comprise at least one of:
a Beacon frame,
a Probe Response frame,
an Association Response frame,
a Reassociation Response frame,
a Link Reconfiguration Response frame, or
a Link Reconfiguration Notify frame.

14. A system of an access point (AP), comprising:
one or more memories collectively containing one or more programs; and
one or more processors, wherein the one or more processors are configured to, individually or collectively, perform an operation comprising:
determining, by an access point (AP), one or more Ultra High Reliability (UHR)-related parameters associated with a neighboring AP; and
transmitting, by the AP, one or more management frames to a non-AP station (STA), the one or more management frames comprising UHR indication information,
wherein the UHR indication information comprises at least one of:
a value indicating that the neighboring supports UHR operations, or
one or more UHR-related subelements comprising the one or more UHR-related parameters.

15. The system of claim 14, wherein the UHR indication information is carried in a Neighbor Report (NR) element.

16. The system of claim 15, wherein the NR element identifies the neighboring AP using a Basic Service Set Identifier (BSSID) corresponding to the neighboring AP.

17. The system of claim 15, wherein the value indicating that the neighboring AP supports UHR operations is carried in a Basic Service Set Identifier (BSSID) Information field of the NR element.

18. The system of claim 15, wherein the one or more UHR-related subelements are carried in an Optional Subelements field of the NR element.

19. The system of claim 14, wherein the one or more management frames comprise at least one of:
a Neighbor Report Response frame,
a Basic Service Set (BSS) Transition Management (BTM) Request frame,
an Access Network Query Protocol (ANQP) Response frame that comprises a Neighbor Report ANQP-element,
a Probe Response frame,
an Association Response frame,
a Reassociation Response frame,
a Link Reconfiguration Response frame, or
a Link Reconfiguration Notify frame.

20. The system of claim 14, wherein one or more subelement values are defined for the one or more UHR-related subelements, comprising at least one of:
a first subelement value identifying a UHR Capabilities subelement, or
a second subelement value identifying a UHR Operation subelement.
